(19) United States
(12) Patent Application Publication
(10) Pub. No.: US 2005/0255371 A1
(43) Pub. Date: Nov. 17, 2005

(54) Fuel cell

(76) Inventors: Kyung-jung Kwon, Seoul (KR); Se-young Oh, Yongin-si (KR)

Correspondence Address: MCGUIREWOODS, LLP, 1750 TYSONS BLVD, SUITE 1800, MCLEAN, VA, 22102, US

(21) Appl. No.: 11/075,869

(22) Filed: Mar. 10, 2005

(30) Foreign Application Priority Data
May 11, 2004 (KR) 10-2004-0033084

(51) Int. Cl. H01M 4/86; H01M 8/02; H01M 8/04

(52) U.S. Cl. 429/40; 429/39; 429/26

(57) ABSTRACT

A fuel cell that has a structure that increases catalyst utilization is provided. The fuel cell includes an anode, a cathode, an electrolyte membrane interposed between the anode and the cathode, and a separator that has a fuel-flow field that supplies fuel to the anode formed on one of its sides, where the fuel-flow field has fuel-channel portions and supporting portions. It also includes a separator that has an oxidant-flow field that supplies an oxidant to the cathode formed on one of its sides, where the oxidant-flow field has oxidant-channel portions and supporting portions. The anode has a pattern corresponding to that of the fuel-channel portions, or the cathode has a pattern corresponding to that of the oxidant-channel portions, or the anode and the cathode have patterns corresponding to those of the fuel-channel portions and the oxidant-channel portions, respectively.

This application claims the benefit of Korean Patent Application No. 2004-33084, filed on May 11, 2004, in the Korean Intellectual Property Office, the disclosure of which is incorporated herein in its entirety by reference.

### BACKGROUND OF THE INVENTION

(a) Field of the Invention

The present invention relates to a fuel cell comprising an anode, a cathode, an electrolyte membrane, and a separator.

(b) Description of the Related Art

Fuel cells are regarded as being the next-generation energy sources since they have a high electricity generation efficiency and are environmentally-friendly. Fuel cells are classified into categories including polymer electrolyte membrane fuel cells (PEMFCs), phosphoric acid fuel cells (PAFCs), molten carbonate fuel cells (MCFCs), and solid oxide fuel is cells (SOFCs) etc. depending on the type of electrolyte used.

Operation temperature, constitutional material, etc. of fuel cells can vary depending on the type of electrolyte used. Conventional fuel cells have a structure illustrated in FIG. 1, which illustrates a partial cross-section of a conventional fuel cell.

Hereinafter, referring to FIG. 1, an operational principle of a fuel cell will be described. A separator 100 includes fuel channels 110 that are paths for supplying fuel to an anode 200. Examples of the fuel include hydrogen, a mixed vapor of a natural gas and steam, an aqueous methanol solution, and a mixed vapor of methanol and water. The fuel flows through the fuel channels 110 and diffuses into the anode 200. The anode 200 is porous and contains a catalyst. The fuel diffused into the anode 200 contacts the catalyst and undergoes a chemical reaction.

A separator 500 includes oxidant channels 510 that are paths for supplying an oxidant to a cathode 400. Examples of the oxidant include oxygen, air, or a mixture of oxygen (or air) with carbon dioxide. The mixture of oxygen (or air) with carbon dioxide is primarily used in MCFCs. The oxidant flows through the oxidant channels 510 to diffuse into the cathode 400. The cathode 400 is porous and contains a catalyst. The oxidant diffuses into the cathode 400, contacts the catalyst, and undergoes a chemical reaction. An electrolyte membrane 300 functions as an ion conductor. That is, the electrolyte membrane 300 transfers an ion generated at the anode 200 to the cathode 400 or an ion generated at the cathode 400 to the anode 200. An electron generated at the anode 200 is supplied to an external circuit, and then returned to the cathode.

Chemical reactions occurring at the anode and the cathode in various types of fuel cells are as follows.

<SOFC>
anode: H₂+O²⁻----->H₂O+2 e⁻
cathode: 2 e⁻+½ O₂----->O²⁻

<MCFC>
anode: H₂+CO₃²⁻----->H₂O+CO₂+2 e⁻
cathode: ½O₂+CO₂+2 e⁻----->CO₃²⁻

<PAFC and PEMFC>
anode: H₂----->2 H⁺+2 e⁻
cathode: 2 H⁺+½ O₂----->H₂O

<DMFC>
anode: CH₃OH+H₂O----->CO₂+6 H⁺+6 e⁻
cathode: 6 H⁺+ 3/2 O₂+6 e⁻----->3 H₂O

FIG. 2 illustrates the diffusion of the reactants through channels of a separator into an electrode in the structure of the fuel cell illustrated in FIG. 1. In most fuel cells, an electrode includes a diffusion layer and a catalyst layer. The diffusion layer is composed of a porous and electronically-conductive material. In general, pores of the diffusion layer are larger than that of the catalyst layer. Referring to FIG. 2, the anode 200 includes a diffusion layer 210 and a catalyst layer 220. The cathode 400 has the same structure as the anode 200 illustrated in FIG. 2.

The diffusion layer 210 provides paths for a fuel to flow smoothly not only to a portion of the catalyst layer 220 just below a fuel channel 110 but also to a portion of the catalyst layer 220 below a supporting portion 120 of the separator 100. The diffusion layer 210 provides paths for discharging products formed in the portion of the catalyst layer 220 below the supporting portion 120 of the separator 100 to the fuel channel 110 as well as in the portion of the catalyst layer 220 just below the fuel channel 110.

However, in spite of the presence of the diffusion layer 210, the mass transfer rate in the portion of the catalyst layer 220 just below the fuel channel 110 is different from that in the portion of the catalyst layer 220 below the supporting portion 120 of the separator 100. In FIG. 2, routes “a” and “c” represent mass transfer routes for the portion of the catalyst layer 220 below the supporting portion 120 of the separator 100, and route “b” represents a mass transfer route for the portion of the catalyst layer 220 just below the fuel channel 110. As illustrated in FIG. 2, routes “a” and “c” are respectively longer than route “b.” Thus, mass transfer rates through routes “a” and “c” are slower than the mass transfer rates through route “b.”

Thus, the current density of the portion of the catalyst layer 220 below the supporting portion 120 of the separator 100 is lower than that of the portion of the catalyst layer 220 just below the fuel channel 110. This means that the portion of the catalyst layer 220 below the supporting portion 120 of the separator 100 has a lower catalyst utilization than the portion of the catalyst layer 220 just below the fuel channel 110. The lower catalyst utilization causes a waste of expensive catalyst and is a critical factor of increasing production costs of a fuel cell, and such a phenomenon also occurs in the cathode.

### SUMMARY OF THE INVENTION

The present invention provides a fuel cell with a structure that prevents a reduction of catalyst utilization.

One aspect of the present invention provides a fuel cell comprising an anode, a cathode, an electrolyte membrane interposed between the anode and the cathode, and a separator with a fuel-flow field that supplies a fuel to the anode that is formed on one side of the separator, is where the fuel-flow field has fuel-channel portions and supporting portions. The fuel cell also comprises a separator that has an oxidant-flow field that supplies an oxidant to the cathode that is formed on one of its sides, where the oxidant-flow field has oxidant-channel portions and supporting portions. In addition, the anode may have a pattern corresponding to the fuel-channel portions, or the cathode may have a pattern corresponding to the oxidant-channel portions, or the anode and the cathode may both have patterns corresponding to the fuel-channel portions and the oxidant-channel portions, respectively.

In the fuel cell according to the present embodiment, an electrode is disposed along channels, but not along supporting portions, and thus there is no dead zone of mass transfer through the electrode. Thus, the catalyst utilization can be maximized in the fuel cell.

### BRIEF DESCRIPTION OF THE DRAWINGS

The above and other features and advantages of the present invention will become more apparent by describing in detail exemplary embodiments thereof with reference to the attached drawings.

FIG. 1 is a cross-sectional view illustrating a basic structure of a conventional fuel cell.

FIG. 2 is a cross-sectional view illustrating reactant diffusion routes in the structure of the conventional fuel cell illustrated in FIG. 1.

FIG. 3 is a cross-sectional view illustrating the structure of a fuel cell according to an embodiment of the present invention.

FIG. 4A is a top view illustrating a separator used in a fuel cell according to an embodiment of the present invention.

FIG. 4B is a top view illustrating an electrode used in a fuel cell according to an embodiment of the present invention.

FIG. 5A is a top view illustrating a separator used in a fuel cell according to another embodiment of the present invention.

FIG. 5B is a top view illustrating an electrode used in a fuel cell according to another embodiment of the present invention.

FIG. 6 is a cross-sectional view illustrating a fuel cell stack obtained by layering fuel cells according to an embodiment of the present invention.

FIG. 7 is a graph showing performance of a fuel cell according to an embodiment of the present invention and a comparative fuel cell.

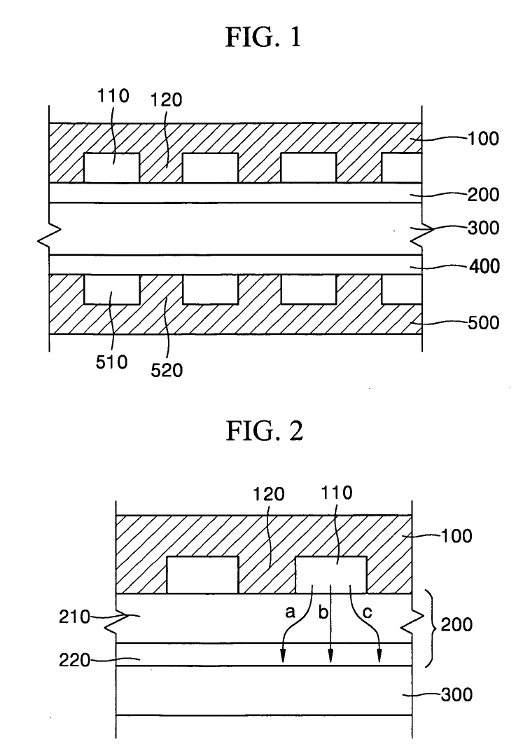

### DETAILED DESCRIPTION OF THE INVENTION

As used herein, the term “separator” refers to a bipolar plate, an end plate, and a cooling plate in a broad sense, unless specified otherwise.

It is well known in the art that a bipolar plate has channels that supply fuels and air and functions as an electron conductor for transporting electrons between membrane electrode assemblies (MEAs). In general, the bipolar plate is non-porous such that fuel and air can be separated, and has excellent electrical conductivity. Further, the bipolar plate has a mechanical strength sufficient to bear a force applied at the time of clamping the fuel cell and has strong resistance to corrosion.

It is also well known in the art that an end plate is an electronically conductive plate that has channels for a fuel or an oxidizing agent only on one side and is attached to MEAs disposed at both ends of a fuel cell stack. In addition, it is well known in the art that a cooling plate is an electronically conductive plate that has channels for a fuel or an oxidizing agent on one side and channels for a cooling fluid on the other side.

In the present invention, the term “flow field” refers to a surface region on a separator, which comprises channels and supporting portions. The channels are grooves on a surface of a separator which function as paths for supplying or discharging reactants or products of an electrode. The supporting portions are interposed between channels and support an MEA.

In the present invention, the anode, the cathode, or the anode and the cathode do not have a sheet form covering the entire flow field of the separator, but have a predetermined pattern corresponding to an area of the channels in the flow field. According to an embodiment of the present invention, the anode may have an outline corresponding to a pattern of the channels of the fuel-flow field and the supporting portions of the fuel-flow field contact the electrolyte membrane. Thus, the anode is introduced into the channels of the fuel-flow field and edges of the anode contact the supporting portions of the fuel-flow field.

Similarly, the cathode may have an outline corresponding to a pattern of the channels of the oxidant-flow field and the supporting portions of the oxidant-flow field contact the electrolyte membrane. Thus, the cathode is introduced into the channels of the oxidant-flow field and edges of the cathode contact the supporting portions of the oxidant-flow field. Another possibility is that the anode may have an outline corresponding to a pattern of the channels of the fuel-flow field and the supporting portions of the fuel-flow field contact the electrolyte membrane. Thus, the anode is introduced into the channels of the fuel-flow field and edges of the anode contact the supporting portions of the fuel-flow field. In addition, the cathode would have an outline corresponding to a pattern of the channels of the oxidant-flow field and the supporting portions of the oxidant-flow field contact the electrolyte membrane. Thus, the cathode is introduced into the channels of the oxidant-flow field so that the edges of the cathode contact the supporting portions of the oxidant-flow field.

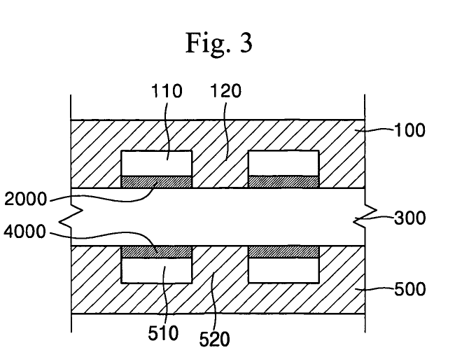

In this way, the technical concept of the present invention can be applied to either the anode or the cathode, or both the anode and the cathode. FIG. 3 is a cross-sectional view illustrating the structure of a fuel cell where the technical concept of the present invention is applied to both the anode and the cathode. The separator illustrated in FIG. 3 is an end plate type of separator.

Referring to FIG. 3, an electrolyte membrane 300 has an anode 2000 attached to one side and a cathode 4000 attached to its other side. A separator 100 on the anode side covers the anode 2000. The anode 2000 is matched with and introduced into channels 110 of the separator 100. Edges of the anode 2000 contact lateral sides of the supporting portions 120, thus providing an electrical connection between the separator 100 and the anode 2000. Similarly, a separator 500 on a cathode side covers the cathode 4000. The cathode 4000 is matched with and introduced into channels 510 of the separator 500. Edges of the cathode 4000 contact lateral sides of the supporting portions 520, thus providing an electrical connection between the separator 500 and the cathode 4000.

The supporting portions 120 and 520 of both separators 100 and 500 contact the electrolyte membrane 300. Such contacts between the supporting portions 120 and 520 and the electrolyte membrane 300 may provide a gas-tight seal. In FIG. 3, although surrounding portions of the fuel cell are omitted, in general, a predetermined gas-tight seal structure may be disposed in surrounding portions of a fuel cell. The fuel cell according to an embodiment of the present invention may not necessarily require a separate gas-tight seal structure due to such contacts.

In FIG. 3, the fuel channels 110 and the oxidant channels 510 are formed in the same direction. In another embodiment of the present invention, the fuel channels 110 and the oxidant channels 510 may be formed in different directions.

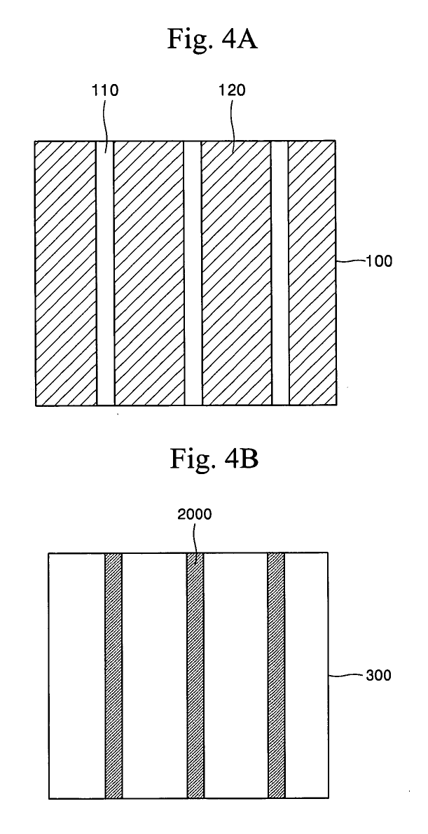

FIG. 4A is a top view illustrating a separator 100 used in a fuel cell according to an embodiment of the present invention, which shows an example of a channel pattern. FIG. 4A shows that the separator 100 has a parallel-flow type of flow field where the flow field comprises supporting portions 120, which are marked with oblique lines, and the channels 110, which are blanked. FIG. 4B is a top view illustrating electrodes 2000 used in a fuel cell according to an embodiment of the present invention, which shows an example of a pattern of electrodes matched with the separator 100 illustrated in FIG. 4A. Referring to FIG. 4B, the electrodes 2000, which are marked with oblique lines, are attached to an electrolyte membrane 300 and in the form of parallel stripes.

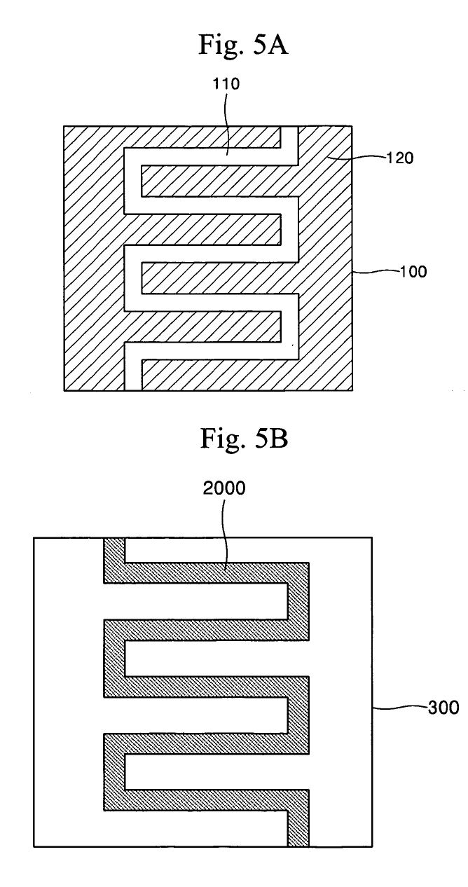

FIG. 5A is a top view illustrating a separator 100 used in a fuel cell according to another embodiment of the present invention, which shows a series-flow type of pattern of channels 110. FIG. 5A shows how the separator 100 has a series-flow type of flow field, the flow field comprising supporting portions 120, which are marked with oblique lines, and the channels 110, which are blanked. FIG. 5B is a top view illustrating an electrode 2000 used in a fuel cell according to another embodiment of the present invention, which shows an example of a pattern of electrode matched with the separator 100 illustrated in FIG. 5A. Referring to FIG. 5B, the electrode 2000, which is marked with oblique lines, is attached to an electrolyte membrane 300 and has a form of continuous bent stripe.

Only certain channel patterns are illustrated in FIGS. 4A and 5A but various other types of channel patterns may be used. Fuel cells having varied channel patterns and matching electrode patterns are also within the scope of the present invention.

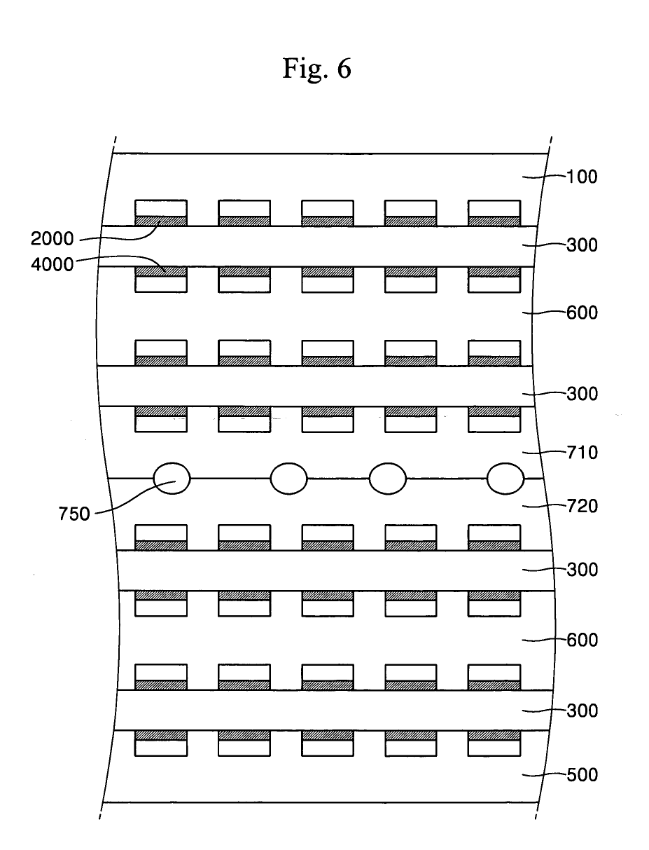

FIG. 6 is a cross-sectional view illustrating a fuel cell stack formed by layering fuel cells according to an embodiment of the present invention, where the fuel cell stack comprises end plates 100 and 500, bipolar plates 600, and cooling plates 710 and 720.

The bipolar plate type of separators 600 have a fuel-flow field that supplies a fuel to an anode 2000 formed on one side of the plate and have an oxidant-flow field that supplies an oxidant to a cathode 4000 formed on its opposite side. Stated differently, the bipolar plate type of separators 600 have an oxidant-flow field that supplies an oxidant to a cathode 4000 formed on one side of the plate and have a fuel-flow field that supplies a fuel to an anode 2000 formed on its opposite side.

The cooling plate type of separator 720 has a fuel-flow field that supplies a fuel to an anode 2000 formed on one of its sides and has a cooling medium-flow field that supplies a cooling medium formed on its opposite side. The cooling plate type of separator 710 has an oxidant-flow field that supplies an oxidant to a cathode 4000 formed on one of its sides and has a cooling medium-flow field that supplies a cooling medium formed on its opposite side.

In a fuel cell according to an exemplary embodiment of the present invention, the anode and the cathode are only disposed inside the channels of the separator, and thus, the anode and the cathode may not necessarily include a gas-permeable layer. Thus, both the anode and the cathode may consist of only a catalyst layer.

Alternatively, in a fuel cell according to another embodiment of the present invention, the anode and the cathode may comprise a catalyst layer and a gas-permeable layer. The gas-permeable layer may be attached to a surface of the catalyst layer which is attached to an electrolyte membrane where the surface of the catalyst layer faces the channel. The gas-permeable layer is coated on the catalyst layer to prevent loss or deterioration of the catalyst layer. The gas-permeable layer may be composed of an electrically conductive gas-permeable membrane such as carbon paper, carbon fiber, and a metal mesh.

The gas-permeable layer may have a sheet form covering all of the channel portions and the supporting portions. In this case, in an assembled fuel cell, the gas-permeable layer has concave portions in a pattern of the channel portions and convex portions in a pattern of the supporting portions. Further, in this case, the gas-permeable layer should have sufficient electrical conductivity.

Any materials known in the art can be used to form the separator, the anode, the cathode, and the electrolyte membrane of the fuel cell according to an embodiment of the present invention. In addition, the fuel cell according to an embodiment of the present invention can be manufactured using a conventional method, except for further comprising a process of printing the electrode in a form of channels onto the electrolyte membrane.

Hereinafter, the present invention will be described in more detail by presenting the following example. The example is for illustrative purposes only, and is not intended to limit the scope of the present invention.

### EXAMPLE

### Example 1

### Fabrication of a Polymer Electrolyte Membrane Fuel Cell (PEMFC)

First, a separator having a fuel-flow field and a separator having an oxidant-flow field were manufactured. Non-porous graphite plates were used to form the separators. The fuel-flow field and the oxidant-flow field had a parallel-flow type structure as illustrated in FIG. 4A. Widths and depths of the channels 110 and widths and heights of the supporting portions 120 were all 762 mm.

Then, 40 g of 5% by weight of a Nafion dispersion (available from Aldrich) was mixed with 3 g of Pt/C catalyst (available Johnson Matti, 20% platinum content by weight). 15 g of water and 60 g of glycerol were added to the resultant mixture to obtain an ink for a catalyst layer.

Next, a Teflon®mask having a fuel-flow field pattern was covered on a blank (Teflon film) and the catalyst layer ink was coated on the blank using a painting method. A Teflon mask having an oxidant-flow field pattern was covered on another blank and the catalyst layer ink was coated on the blank. Then, the coated blanks were dried in an oven at 135° C. for 1 hour.

After drying, the dried blanks were respectively attached to both sides of an electrolyte membrane (Nafion 117, available from Dupont) by hot-pressing to ensure contact between the catalyst layers and the electrolyte membrane. Operating conditions of the hot-pressing are as follows: temperature 125° C., pressure 80 atm, and pressing time 90 sec. Then, the blanks were peeled off to obtain a membrane electrode assembly (MEA).

Then, the separators were attached to both sides of the MEA so that the separator with a fuel-flow field was disposed on the catalyst layer with a fuel-flow field pattern and the separator with an oxidant-flow field was disposed on the catalyst layer with an oxidant-flow field pattern, to produce a unit cell. The catalyst layer with a fuel-flow field pattern was an anode and the catalyst layer with an oxidant-flow field pattern was a cathode. Each catalyst layer was matched with the channels of each flow field.

### Comparative Example 1

### Fabrication of a PEMFC

A unit cell was produced in the same manner as in Example 1, except that the catalyst layer ink was coated on the entire blank without using a mask. Thus, the electrode obtained from Comparative Example 1 did not have the same pattern as that of the channels, but had a sheet form covering the entire channel portions and the supporting portions.

The electrodes of the unit cells obtained from Example 1 and Comparative Example 1 consist of only a catalyst layer, without a gas-permeable layer. Although the actual area of the electrode of the unit cell obtained from Example 1 was different from that obtained from Comparative Example 1, the amount of catalyst used per area of the electrode of the unit cell obtained from Example 1 was the same as that obtained from Comparative Example 1, which was 0.35 mg/cm².

Performance results of Example 1 and Comparative Example 1

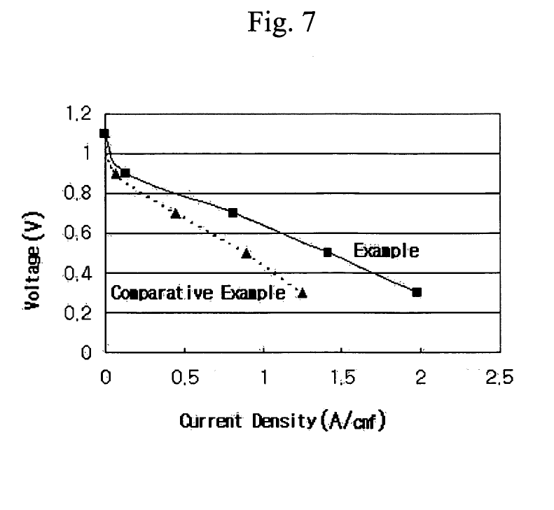

The unit cells were operated using hydrogen (relative humidity: 100%) as a fuel and air (relative humidity: 50%) as an oxidant at an operative temperature of 80° C. A graph showing performance of the unit cell of Example 1 and the unit cell of Comparative Example 1 is illustrated in FIG. 7.

As illustrated in FIG. 7, a current density of the unit cell obtained from Example 1 was much higher than that obtained from Comparative Example 1 at the same cell voltage. From the results, it was confirmed that the fuel cell according to an embodiment of the present invention had significantly higher catalyst utilization. In other words, the fuel cell according to an embodiment of the present invention can generate the same amount of electrical power as the conventional fuel cell even when using lower amounts of a catalyst compared to the conventional fuel cell.

In the fuel cell according to an embodiment of the present invention, an electrode is disposed along the channels, but not along the supporting portions, and thus there is no dead zone of a mass transfer through the electrode. Consequently, catalyst utilization can be maximized in the fuel cell. Further, in the fuel cell according to an embodiment of the present invention, since contacts between the supporting portions and the electrolyte membrane may provide a gas-tight seal, the fuel cell may not necessarily require a separate gas-tight seal structure.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A fuel cell, comprising:
an anode;
a cathode;
an electrolyte membrane;
a separator that has a fuel-flow field that supplies a fuel to the anode formed on one of its sides, the fuel-flow field having fuel-channel portions and supporting portions; and
a separator that has an oxidant-flow field that supplies an oxidant to the cathode formed on one of its sides, the oxidant-flow field having oxidant-channel portions and supporting portions,
wherein the anode has a pattern corresponding to that of the fuel-channel portions, or the cathode has a pattern corresponding to that of the oxidant-channel portions, or the anode and the cathode have patterns corresponding to those of the fuel-channel portions and the oxidant-channel portions, respectively.

2. The fuel cell of claim 1,
wherein the separator that has a fuel-flow field that supplies a fuel to the anode formed on one of its sides has an oxidant-flow field that supplies an oxidant to a cathode formed on its opposite side.

3. The fuel cell of claim 1,
wherein the separator that has an oxidant-flow field that supplies an oxidant to the cathode formed on one of its sides has a fuel-flow field that supplies a fuel to an anode formed on its opposite side.

4. The fuel cell of claim 1,
wherein the separator that has a fuel-flow field that supplies a fuel to the anode formed on one of its sides has a cooling medium-flow field that supplies a cooling medium formed on its opposite side.

5. The fuel cell of claim 1,
wherein the separator that has an oxidant-flow field that supplies an oxidant to the cathode formed one of its sides has a cooling medium-flow field that supplies a cooling medium formed on its opposite side.

6. The fuel cell of claim 1,
wherein both the anode and the cathode consist of only a catalyst layer.

7. The fuel cell of claim 1,
wherein both the anode and the cathode comprise a catalyst layer and a gas-permeable layer and the gas-permeable layer is attached to a surface of the catalyst layer.

8. The fuel cell of claim 7,
wherein the gas-permeable layer has a sheet form that covers the all of the channel portions and the supporting portions.

9. A fuel cell stack formed by layering the fuel cells of claim 1,
wherein the fuel cell stack comprises end plates and a plurality of bipolar plates and cooling plates.

10. The fuel cell stack of claim 9,
wherein the bipolar plate type of separators have a fuel-flow field that supplies a fuel to an anode formed on one side of the plate and have an oxidant-flow field that supplies an oxidant to a cathode formed on its opposite side, and
wherein the cooling plate type of separator has a fuel-flow field that supplies a fuel to an anode formed on one of its sides and has a cooling medium-flow field that supplies a cooling medium formed on its opposite side.
